(19) United States
(12) Patent Application Publication
(10) Pub. No.: US 2005/0253476 A1
(43) Pub. Date: Nov. 17, 2005

(54) Pole body and pole tip connections used with rotating machines

(76) Inventor: Ping Zhong, Austin, TX (US)

Correspondence Address: FULBRIGHT & JAWORSKI L.L.P., 600 CONGRESS AVE., SUITE 2400, AUSTIN, TX, 78701, US

(21) Appl. No.: 10/846,163

(22) Filed: May 14, 2004

(51) Int. Cl. H02K 1/18

(52) U.S. Cl. 310/218

(57) ABSTRACT

Pole body and pole tip connections used with rotating machines. In one embodiment, a rotor body; a non-laminated pole body extending from the rotor body, the non-laminated pole body having a top surface and a male connector projecting from the top surface; and a non-laminated pole tip having a female connector configured to connect to the male connector of the non-laminated pole body. Other embodiments of the present apparatuses are included.

### BACKGROUND OF THE INVENTION

1. Field of the Invention

The invention relates generally to the field of rotating machines, such as motors and generators. More particularly, it relates to pole body and pole tip connections used with such machines.

2. Description of Related Art

For high horsepower and high-speed (1,500 RPM or more) synchronous motors and generators, solid poles (including pole body and pole tip) are typically used. Due to thermal limitations, copper sheets (known in the art as strap winding) are typically used for the rotor windings (also known in the art as rotor field windings or field windings) to improve thermal conductivity and to reduce temperature rise.

For solid pole designs, pole tips and pole bodies have been made integral with each other and the resulting poles have been either integral with the rotor body or connected to the rotor body using one or more dovetail connections (the rotor body having the male connector and the pole body having the female connector, or vice-versa). For solid pole designs, pole tips also have been bolted to pole bodies where the pole body is integral with the rotor body.

In cases where integral poles (rotor body, pole body, and pole tip being integral with each other) have been used, the field winding has been made of several pieces that are brazed together around the pole body. This technique for positioning the winding around the pole body has been used because the existence of the integral pole tip/pole body/rotor body prevents a pre-formed winding from being slipped over the pole body from either the top or the bottom. This procedure can require a long manufacturing time, is generally costly, and can make maintenance difficult. The use of integral poles also requires additional, generally complicated locking devices to lock the winding in place.

Bolted pole tip connections require many tapped holes in the pole tip and the pole body, as well as high-strength bolts. Due to high thermal and centrifugal force induced stress and fatigue problems, the bolted connection generally requires extra pre-tensioning, either by shrink fitting or by extra pre-tensioning the bolts. Also, the bolt connection generally requires frequent maintenance due to high thermal and centrifugal force induced stress and fatigue problems.

With integral pole tip and pole body constructions, the dovetail connection that has been used to connect the pole and rotor body poses certain problems as well. With this type of connection, even though the winding can be slipped around the pole body (from the bottom) before the pole body is attached to the shaft, the dovetail connection endures all the centrifugal and electromagnetic forces that are exerted on the pole during operation of the machine.

### SUMMARY OF THE INVENTION

The present apparatuses include a connection between the pole tip and the pole body. In embodiments where the pole body extends from and is integral with the rotor, and even in embodiments where the pole body extends from and is attached to (e.g., through a female connector-male connector engagement) the rotor, the present pole body-pole tip connections will not undertake all the forces (centrifugal and electro-magnetic) that are exerted on the pole body during operation of the rotating machine with which the pole is used. This reduces the loading on the pole body-pole tip connection as compared to the loading endured by the known dovetail connection between a pole (integral pole body and tip) and a rotor body. Furthermore, in contrast to poles that are integral with rotor bodies and that have integral pole tips, the winding that is positioned around the pole body connected as presently disclosed will not require an additional lengthy manufacturing procedure, such as brazing each winding in place. Instead, the winding may be slipped over the pole body before the pole tip is connected to the pole body. Maintenance of the winding should be easier because the pole tip may be removed from the pole body.

The pole body-pole tip connections of the present apparatuses should increase manufacturing productivity, reduce manufacturing cost, enable easier maintenance, and improve structural reliability. All of the motors and generators presently discussed may be salient pole synchronous motors or generators.

One embodiment of the present apparatuses includes a rotor body; a non-laminated pole body extending from the rotor body, the non-laminated pole body having a top surface and a male connector projecting from the top surface; a pole tip having a female connector configured to connect to the male connector of the non-laminated pole body; and a winding positioned around the non-laminated pole body.

Another embodiment of the present apparatuses includes a rotor body; a non-laminated pole body extending from the rotor body, the non-laminated pole body having a top surface and a male connector projecting from the top surface; and a non-laminated pole tip having a female connector configured to connect to the male connector of the non-laminated pole body.

Yet another embodiment of the present apparatuses includes a non-laminated pole tip having a female connector that is configured to connect to a male connector of a non-laminated pole body of a rotor assembly.

Additional embodiments of the present apparatuses, and details associated with those embodiments, are set forth below.

### BRIEF DESCRIPTION OF THE DRAWINGS

The following drawings illustrate by way of example and not limitation. The use of identical reference numerals does not necessarily indicate an identical structure. Rather, the same reference numeral may be used to indicate a similar feature or a feature with similar functionality.

FIG. 1 is a cross-sectional front view of one embodiment of the present apparatuses. The figure shows a pole body having two male connectors, a pole tip having two female connectors, a winding, and part of a rotor body.

FIG. 2 is a cross-sectional front view of another embodiment of the present apparatuses, which differs from the embodiment shown in FIG. 1 by the shape of the male and female connectors, which are T-shaped in this figure.

FIG. 3 is a cross-sectional front view of another embodiment of the present apparatuses, which differs from the embodiments shown in FIGS. 1 and 2 by the shape of the male and female connectors, which are triangular-shaped in this figure.

FIG. 4 depicts a partial view of one of the present male connectors.

FIG. 5 depicts a partial view of one of the present female connectors.

FIG. 6 is a cross-sectional front view an embodiment of the present apparatuses that includes a dovetail connection between the pole body and rotor body.

FIG. 7 is a cross-sectional front view of one embodiment of the present apparatuses. The figure shows multiple pole bodies, pole tips, windings, and a rotor body.

FIG. 8 is a perspective view of a cross-section of one embodiment of the present apparatuses. There is no winding positioned around the pole body in this embodiment.

### DESCRIPTION OF ILLUSTRATIVE EMBODIMENTS

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus that “comprises,” “has,” or “includes” one or more elements possesses those one or more elements, but is not limited to possessing only those one or more elements. Likewise, an element of an apparatus that “comprises,” “has,” or “includes” one or more features possesses those one or more features, but is not limited to possessing only those one or more features.

Thus, and by way of example, an apparatus “comprising” a rotor body; a non-laminated pole body extending from the rotor body, the non-laminated pole body having a top surface and a male connector projecting from the top surface; and a non-laminated pole tip having a female connector configured to connect to the male connector of the non-laminated pole body, has, but is not limited to having only, the recited elements and features. That is, the apparatus possesses at least the recited elements and features, but does not exclude other elements or features that are not expressly recited, such as an additional pole body or bodies, and male connectors extending from the top surface of such bodies.

The terms “a” and “an” are defined as one or more than one unless this disclosure explicitly requires otherwise.

The term “rotor body” is defined as any part of a rotor, including the shaft, from which poles may extend or to which poles may be connected.

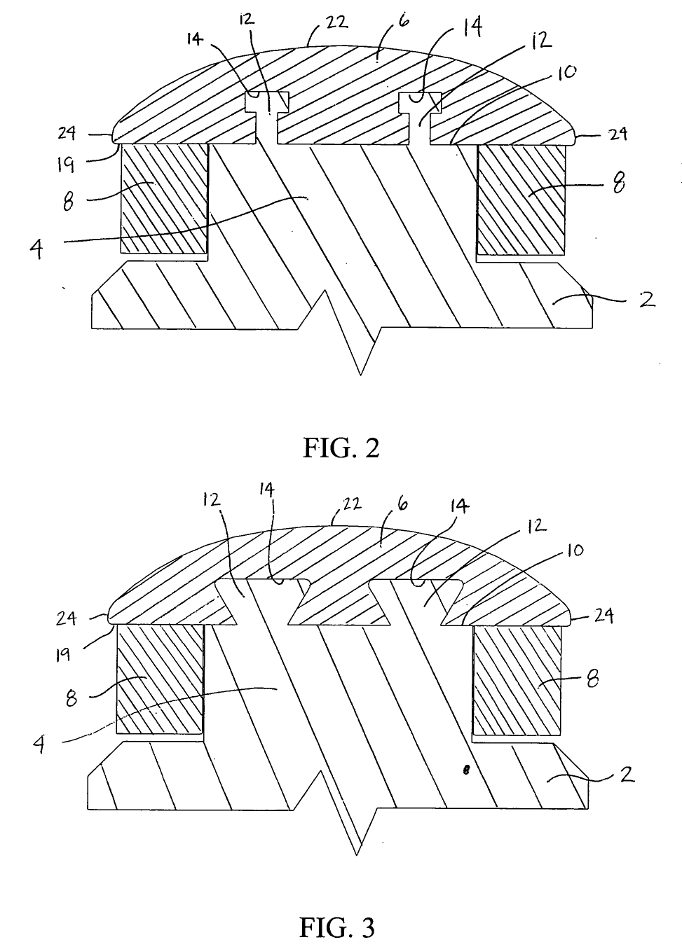

The term “substantially equal” is defined as at least close to (and can include) a given value or dimension. U.S. Pat. No. 3,089,049 by Sills (Sills) shows an example of two dimensions that are not substantially equal. The height of the pole body disclosed in Sills is not substantially equal to the depth of the winding that is positioned around the pole body (see Sills, FIG. 2 and FIG. 3). This follows because the Sills pole body must have a height that accommodates the depth of the winding plus the depth of a groove in the pole body used to connect the pole body to the pole tip (see groove 26 in the figures; and column 3, line 58).

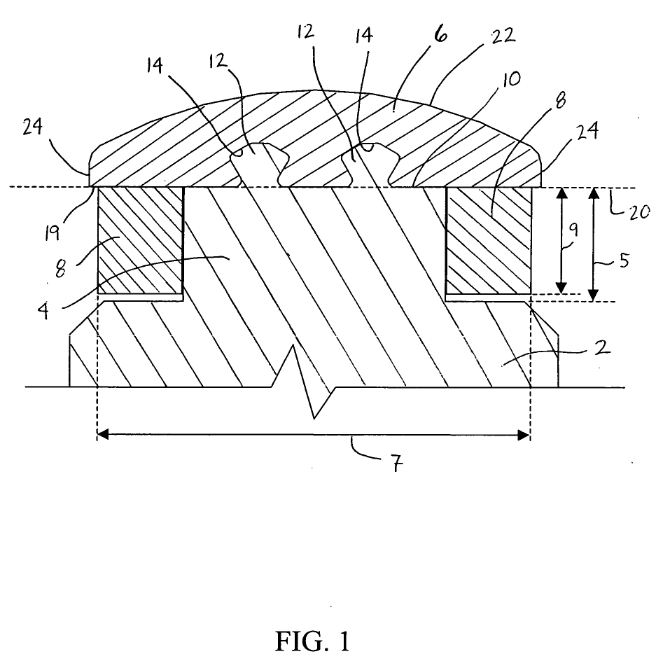

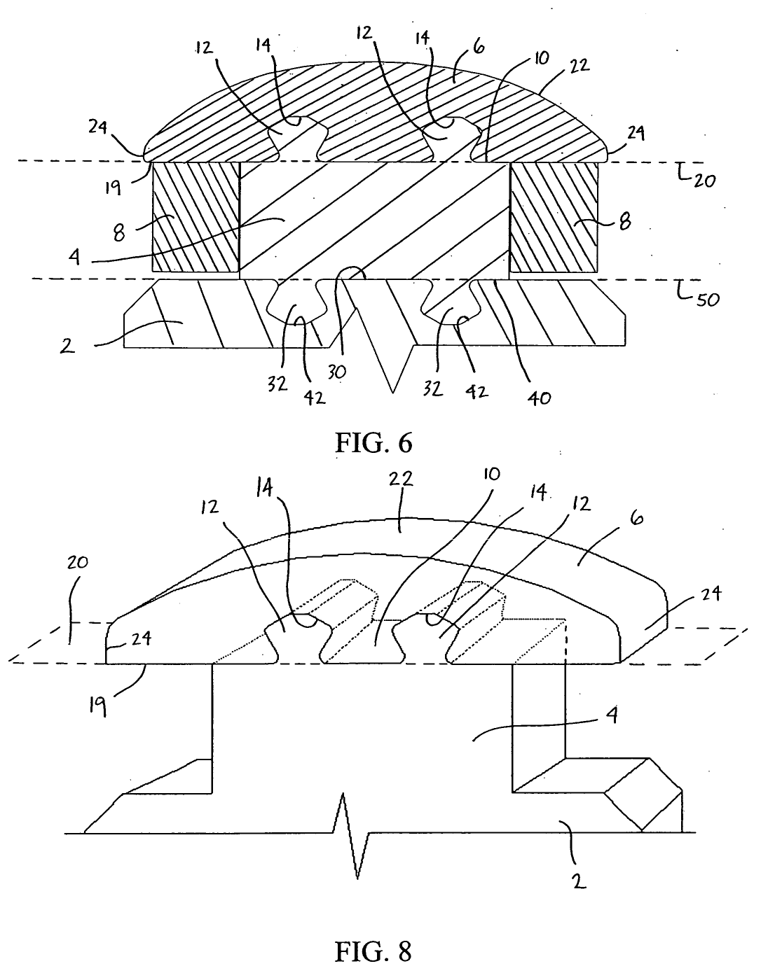

FIG. 1 shows one embodiment of the present apparatuses in cross section. The embodiment includes rotor body 2, pole body 4, pole tip 6, and winding 8. Although not shown, those of skill in the art will understand that a plate biased toward pole tip 6 (e.g., by multiple springs positioned in recesses in rotor body 2) may be positioned between rotor body 2 and winding 8 in order to bias winding 8 toward pole tip 6 such that when rotation of rotor body 2 begins, winding 8 will already be as close to pole tip 6 as possible. As shown in FIG. 1, pole body 4 extends from, and is integral with, rotor body 2. In other embodiments of the present apparatuses, pole body 4 is not integral with rotor body 2 (see FIG. 6). Pole body 4 and pole tip 6 each may be non-laminated or laminated. That is, both pole tip 6 and pole body 4 may be laminated, or only one of the two may be laminated while the other is non-laminated. For example, FIG. 8 shows an embodiment of the present apparatuses where pole body 4 and pole tip 6 are non-laminated.

Continuing with FIG. 1, pole body 4 includes top surface 10. Male connectors 12 project from top surface 10. While the depicted embodiment of pole body 4 is shown having two male connectors 12 projecting from top surface 10, in other embodiments of the present apparatuses, pole body 4 may have only one, or a total of three or more (such as 3, 4, 5, 6, or more) male connectors 12 projecting from top surface 10. Pole tip 6 of the embodiment shown in FIG. 1 has a top surface 22, a bottom surface 19, side surfaces 24, and two female connectors 14. In other embodiments, pole tip 6 may have one or more female connectors, and may have at least the same number of female connectors as there are male connectors projecting from the top surface of the pole body. Female connectors 14 of pole tip 6 are configured to connect to (and, in the embodiment shown, are connected to) male connectors 12 of pole body 4, and vice-versa.

In the depicted embodiment, bottom surface 19 is flat (or at least substantially flat) and lies in plane 20. Both plane 20 and bottom surface 19 are substantially parallel to the rotation axis (not shown) of rotor body 2. Side surfaces 24 of pole tip 6 are flat (or at least substantially flat) and substantially perpendicular to plane 20. When pole tip 6 is connected to pole body 4 as shown in FIG. 1, top surface 10 (which also is flat, or at least substantially flat) of pole body 4 also lies in plane 20 (or at least substantially in plane 20). In the embodiment shown, female connectors 14 of pole tip 6 are positioned on only one side of plane 20. Female connectors 14 may also be characterized as being recesses in pole tip 6 that are positioned on only one side of plane 20. The different surfaces of pole tip 6 (bottom, top and sides) may be connected with each other with rounds or sharp angles.

Male connectors 12 and female connectors 14 are of dovetail design in the embodiment shown in FIG. 1. In other embodiments, the connectors may be of a different design. For example, they may have a T-shaped design (FIG. 2), a triangular-shaped design (FIG. 3), or any other suitable design.

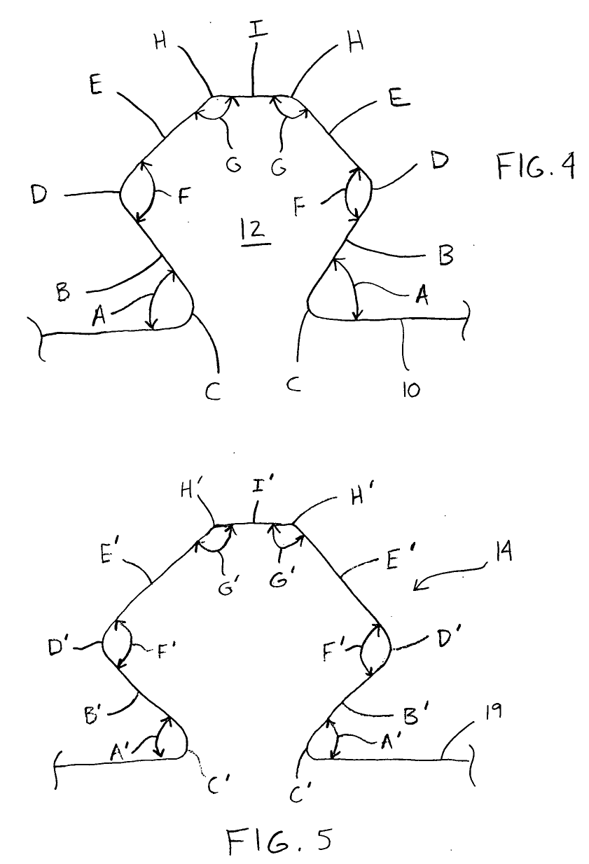

Exemplary dimensions for a version of the FIG. 1 embodiment of the present apparatuses that may be a part of a synchronous motor or generator having a salient pole design, four poles, and a capability of 15,000 HP follow. (A generator having a “capability” of 15,000 HP has the capacity to generate 15,000 HP; a motor having a “capability” of 15,000 HP has the capacity to deliver 15,000 HP.) Depth 9 of winding 8 may be 5 inches; width 7 of winding 8 may be 21 inches; the length (the dimension running into the page) of winding 8 may be 57 inches; height 5 of pole body 4 may be 5.5 inches; the width of pole body 4 may be 12.5 inches; the depth (the direction running into the page) of pole body 4 may be 48 inches; the height (same direction as height 5 and depth 9) of side surfaces 24 of pole tip 6 may be 0.75 inches; top surface 22 of pole tip 6 may have a radius of 21.5 inches; the radius of the rounds connecting top surface 22 to side surfaces 24 may be 0.75 inches; and the depth (the direction running into the page) of pole tip 6 may be 60 inches. Continuing with exemplary dimensions, and turning to FIG. 4, which depicts certain features of one embodiment of male connector 12, angle A may be 60°; the length of segment B may be 1.5 inches; the radius of curved segment C connecting segment B to top surface 10 may be 0.25 inches; the length of segment E may be 1 inch; the radius of curved segment D connecting segment B to segment E may be 0.25 inches; angle F may be 90°; the length of segment I may be 0.75 inches; the radius of curved segment H connecting segment E to segment I may be 0.25 inches; and angle G may be 150°.

Continuing with exemplary dimensions, and turning to FIG. 5, which depicts certain features of one embodiment of female connector 14, angle A′ may be 60°; the length of segment B′ may be 1.5 inches; the radius of curved segment C′ connecting segment B′ to bottom surface 19 may be 0.25 inches; the length of segment E′ may be 1 inch; the radius of curved segment D′ connecting segment B′ to segment E′ may be 0.25 inches; angle F′ may be 90°; the length of segment I′ may be 1 inch; the radius of curved segment H′ connecting segment E′ to segment I′ may be 0.25 inches; and angle G′ may be 150°.

Exemplary materials that may be used to construct the features of the embodiment of the present apparatuses shown in FIG. 1 include: AISI 4340 (an alloy steel) for rotor body 2 and pole body 4; AISI 4340 for pole tip 6; and copper for winding 8.

These dimensions and materials are provided for illustrative purposes only. It should be understood that the present apparatuses are not intended to be limited to the particular dimensions and materials disclosed. Other embodiments may have different suitable dimensions and may use different suitable materials.

Finally in FIG. 1, winding 8 is positioned around pole body 4. In this embodiment, pole body 4 has a height 5 that is substantially equal to the depth 9 of winding 8. Even though winding 8 is positioned around pole body 4 in the embodiment of FIG. 1, and height 5 of pole body 4 is substantially equal to depth 9 of winding 8, in other embodiments there may be no winding positioned around the pole body, or, if there is, the height of the pole body may not be substantially equal to the depth of the winding. FIG. 8, for example, shows an embodiment where a winding is not positioned around the pole body. Moreover, in other embodiments, the pole tip need not be connected to a pole body. In yet other embodiments, the apparatus may comprise, for example, only pole tip 6, where the pole tip is non-laminated and has a female connector configured to connect to a male connector of a non-laminated pole body of a rotor assembly.

FIG. 6 illustrates an embodiment of the present apparatuses similar to the embodiment shown in FIG. 1, except that a dovetail connection exists between pole body 4 and rotor body 2. Specifically, pole body 4 includes a bottom surface 30 and male connectors 32 projecting from bottom surface 30. Although only two male connectors 32 are shown, three or more (e.g., 3, 4, 5, 6, or more) could be used as desired to best suit a given application. Rotor body 2 includes a pole body supporting surface 40 that includes two female connectors 42 that are configured to connect to (and, in the embodiment shown, are connected to) male connectors 32 of pole body 4, and vice-versa. In the depicted embodiment, pole body supporting surface 40 is flat (or at least substantially flat), as is bottom surface 30 of pole body 4. These surfaces lie in a plane 50 that is (a) substantially parallel to plane 20 (in which top surface 10 of pole body 4 and bottom surface 19 of pole tip 6 lie), and (b) substantially parallel to the rotation axis (not shown) of rotor body 2. In the embodiment shown, male connectors 32 of pole body 4 are positioned only on one side of plane 50. Female connectors 42 may also be characterized as being recesses in rotor body 2 that are positioned only on one side of plane 50.

Male connectors 32 and female connectors 42 are of dovetail design in the embodiment shown in FIG. 6. In other embodiments, the connectors may be of a different design. For example, they may have a T-shaped design (such as is shown in FIG. 2), a triangular-shaped design (such as is shown in FIG. 3), or any other suitable design.

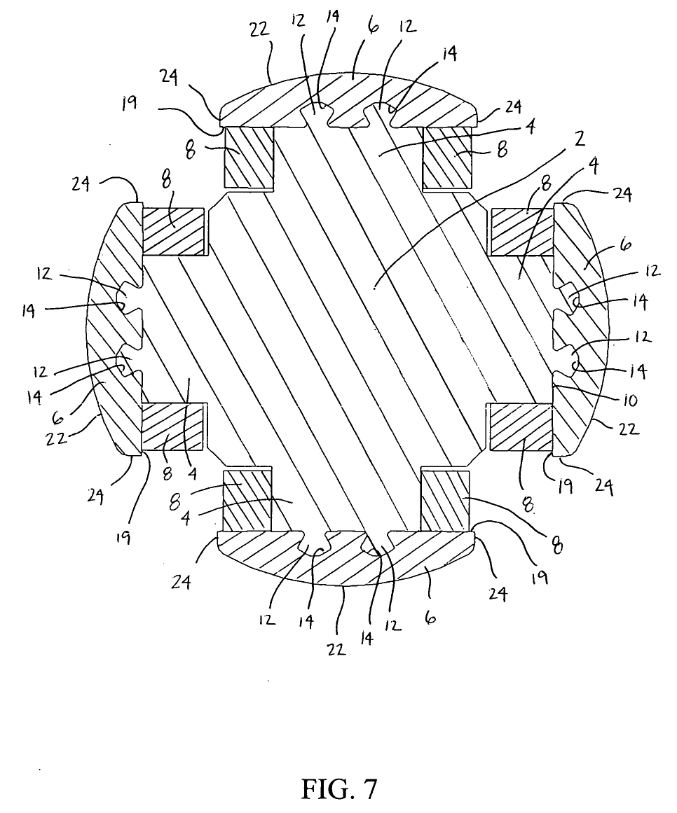

Another embodiment of the present apparatuses is illustrated in FIG. 7. In this embodiment, four pole bodies 4 extend from rotor body 2 at 90 degree angles from each other. In other embodiments, two pole bodies may be provided or more than four pole bodies may be provided (e.g., 6, 8, 10 or more) and may extend from the rotor body. A winding 8 is positioned around each pole body 4. It should be understood that while each pole body 4 is shown having two male connectors 12 projecting from its top surface 10, and each pole tip 6 is shown having two female connectors 14 that are configured to connect to (and that, in the depicted embodiment, are connected to) the corresponding male connectors, the number of male connectors may be different for different pole bodies. Likewise, the number of female connectors may be different for different pole tips. In addition, even though in the embodiment of FIG. 7 every pole body is connected to a pole tip, and a winding is positioned around every pole body, in other embodiments no windings are present, or a winding is positioned around some (e.g., one) but less than all of the pole bodies. In addition, in other embodiments, only some pole bodies may be connected to a pole tip and the number of female connectors in each pole tip may be different from the number of male connectors in the corresponding pole body.

In FIG. 8, a partial perspective view of a cross-section (cross-hatching not shown for clarity) of an embodiment of the present apparatuses is shown. This figure partially illustrates the depth of top surface 10 of pole body 4. This figure illustrates one manner of configuring pole tip 6 such that pole tip 6 may connect to and disconnect from pole body 4 by sliding female connectors 14 over and off of male connectors 12. Female connectors 14 may extend from the front of pole tip 6 to the back of pole tip 6. Male connectors 12 may extend from the front of pole body 4 to the back of pole body 4. The length (the dimension extending at an angle into the page) of female connectors 14 may be greater than the depth (the dimension extending at an angle into the page) of the winding (not shown) positioned around pole body 4 by ½ inches at both the front and back of pole tip 6. Although no winding is positioned around pole body 4, it will be understood by those of ordinary skill in the art that, because male connectors 12 project from top surface 10 and are positioned above plane 20 (or at least substantially above plane 20), even if a winding were positioned around pole body 4, pole tip 6 could still be connected to and disconnected from pole body 4 as described above.

To anchor the present pole tips in place once they have been connected to a pole body, keys may be driven into gaps (e.g., key recesses) between the female connector(s) and the corresponding male connector(s) at both ends of the pole and from opposite directions. In certain embodiments, there may be no gaps between the male and female connectors for a given connection other than the key gaps, or recesses. The use of keys for anchoring these types of connections between pole body and rotor is well known. In one embodiment of the present apparatuses, the pole tip and pole body are configured to accept these keys. In other embodiments, only the pole tip or the pole body may be configured to accept the keys. In one embodiment, these keys are tapered. To disconnect the pole tip from the pole body through sliding once the pole tip is anchored in place, the keys may be removed first. Other suitable anchoring structures, such as welds, may be used instead of keys. Keys may also be used to better secure the connection between pole bodies and rotors that are connected to each other with male and female connectors, as shown in FIG. 6.

Embodiments of the present apparatuses are configured to be part of a motor or generator capable of operating at at least 1,500 revolutions per minute. Other, and in some cases the same, embodiments of the present apparatuses are configured to be part of a synchronous motor or generator capable of at least 1,000 horsepower. Embodiments of the present apparatuses also are configured to be part of a generator capable of generating at least 750 watts.

It should be understood that the present apparatuses are not intended to be limited to the particular forms disclosed. Rather, they are to cover all modifications, equivalents, and alternatives falling within the scope of the claims. Furthermore, the claims are not to be interpreted as including means-plus- or step-plus-function limitations, unless such a limitation is explicitly recited in a given claim using the phrase(s) “means for” or “step for,” respectively.

1. An apparatus comprising:
a rotor body;
a non-laminated pole body extending from the rotor body, the non-laminated pole body having a top surface and a male connector projecting from the top surface;
a pole tip having a female connector configured to connect to the male connector of the non-laminated pole body; and
a winding positioned around the non-laminated pole body.

2. The apparatus of claim 1, where the apparatus includes multiple pole bodies extending from the rotor body, and each pole body has a top surface and a male connector projecting from the top surface.

3. The apparatus of claim 2, further comprising a pole tip connected to each pole body, each pole tip having a female connector configured to connect to the male connector of a pole body.

4. The apparatus of claim 1, where the pole tip has multiple female connectors.

5. The apparatus of claim 4, where the pole body has multiple male connectors projecting from the top surface, and each male connector is configured to connect to a female connector of the pole tip.

6. The apparatus of claim 1, where the pole tip is non-laminated.

7. The apparatus of claim 1, where the pole tip is configured to connect to and disconnect from the pole body by sliding the female connector over and off of the male connector.

8. The apparatus of claim 1, where the pole body has a height, the winding has a depth, and the height of the pole body is substantially equal to the depth of the winding.

9. The apparatus of claim 1, where the pole body is integral with the rotor body.

10. The apparatus of claim 1, where the apparatus is configured to be part of a motor or generator capable of operating at at least 1,500 revolutions per minute.

11. The apparatus of claim 1, where the apparatus is configured to be part of a motor capable of at least 1,000 horsepower.

12. The apparatus of claim 1, where the apparatus is configured to be part of a generator capable of generating at least 750 watts.

13. An apparatus comprising:
a rotor body;
a pole body extending from the rotor body, the pole body having a top surface and a male connector projecting from the top surface;
a non-laminated pole tip having a female connector configured to connect to the male connector of the pole body; and
a winding positioned around the pole body;
where the pole body has a height, the winding has a depth, and the height of the pole body is substantially equal to the depth of the winding.

14. The apparatus of claim 13, where the apparatus includes multiple pole bodies extending from the rotor body, and each pole body has a top surface and a male connector projecting from the top surface.

15. The apparatus of claim 14, further comprising a pole tip connected to each pole body, each pole tip having a female connector configured to connect to the male connector of a pole body.

16. The apparatus of claim 13, where the pole tip has multiple female connectors.

17. The apparatus of claim 16, where the pole body has multiple male connectors projecting from the top surface, and each male connector is configured to connect to a female connector of the pole tip.

18. The apparatus of claim 13, where the pole body is non-laminated.

19. The apparatus of claim 13, where the pole tip is configured to connect to and disconnect from the pole body by sliding the female connector over and off of the male connector.

20. The apparatus of claim 13, where the pole body is integral with the rotor body.

21. The apparatus of claim 13, where the apparatus is configured to be part of a motor or generator capable of operating at at least 1,500 revolutions per minute.

22. The apparatus of claim 13, where the apparatus is configured to be part of a motor capable of at least 1,000 horsepower.

23. The apparatus of claim 13, where the apparatus is configured to be part of a generator capable of generating at least 750 watts.

24. An apparatus comprising:
a rotor body;
a non-laminated pole body extending from the rotor body, the non-laminated pole body having a top surface and a male connector projecting from the top surface; and
a non-laminated pole tip having a female connector configured to connect to the male connector of the non-laminated pole body.

25. The apparatus of claim 24, where the apparatus includes multiple pole bodies extending from the rotor body, and each pole body has a top surface and a male connector projecting from the top surface.

26. The apparatus of claim 25, further comprising a pole tip connected to each pole body, each pole tip having a female connector configured to connect to the male connector of a pole body.

27. The apparatus of claim 24, where the pole tip has multiple female connectors.

28. The apparatus of claim 27, where the pole body has multiple male connectors projecting from the top surface, and each male connector is configured to connect to a female connector of the pole tip.

29. The apparatus of claim 24, where the pole tip is configured to connect to and disconnect from the pole body by sliding the female connector over and off of the male connector.

30. The apparatus of claim 24, further comprising a winding positioned around the pole body, the pole tip being configured to connect to and disconnect from the pole body by sliding the female connector over and off of the male connector.

31. The apparatus of claim 24, further comprising a winding positioned around the pole body, and where the pole body has a height, the winding has a depth, and the height of the pole body is substantially equal to the depth of the winding.

32. The apparatus of claim 24, where the pole body is integral with the rotor body.

33. The apparatus of claim 24, where the apparatus is configured to be part of a motor or generator capable of operating at at least 1,500 revolutions per minute.

34. The apparatus of claim 24, where the apparatus is configured to be part of a motor capable of at least 1,000 horsepower.

35. The apparatus of claim 24, where the apparatus is configured to be part of a generator capable of generating at least 750 watts.

36. An apparatus comprising:
a non-laminated pole tip having a female connector configured to connect to a male connector of a non-laminated pole body of a rotor assembly.

37. The apparatus of claim 36, where the pole tip has multiple female connectors.

38. The apparatus of claim 36, where the pole tip is configured to connect to and disconnect from the pole body by sliding the female connector over and off of the male connector.

39. The apparatus of claim 38, further comprising a winding positioned around the pole body.

40. The apparatus of claim 36, where the apparatus is configured to be part of a salient pole synchronous motor or generator.

41. The apparatus of claim 36, where the apparatus is configured to be part of a motor or generator capable of operating at at least 1,500 revolutions per minute.

42. The apparatus of claim 36, where the apparatus is configured to be part of a motor capable of at least 1,000 horsepower.

43. The apparatus of claim 36, where the apparatus is configured to be part of a generator capable of generating at least 750 watts.
